(19) United States
(12) Patent Application Publication
(10) Pub. No.: US 2021/0158749 A1
(43) Pub. Date: May 27, 2021

(54) ORGANIC LIGHT-EMITTING DIODE (OLED) DISPLAY PANEL AND OPERATING METHOD THEREOF

(71) Applicant: WUHAN CHINA STAR OPTOELECTRONICS SEMICONDUCTOR DISPLAY TECHNOLOGY CO., LTD., Wuhan (CN)

(72) Inventors: Wenqi Li, Wuhan (CN); Wenxu Xianyu, Wuhan (CN)

(73) Assignee: WUHAN CHINA STAR OPTOELECTRONICS SEMICONDUCTOR DISPLAY TECHNOLOGY CO., LTD., Wuhan (CN)

(21) Appl. No.: 17/048,082

(22) PCT Filed: Feb. 20, 2019
(86) PCT No.: PCT/CN2019/075502

§ 371 Date: Oct. 15, 2020

(51) Int. Cl. G09G 3/3208; G06F 3/041; G06F 3/044; G06F 3/045; G06F 9/451; G06F 21/32; G06K 9/00

(52) U.S. Cl. CPC G09G 3/3208; G06F 3/0414; G06F 3/044; G06F 2221/2149; G06F 9/453; G06F 21/32; G06K 9/00013; G06F 3/045

(57) ABSTRACT

An organic light-emitting diode (OLED) display panel is provided. The OLED display panel includes touch sensors, pressure sensors and fingerprint recognition sensors integrated in the OLED display panel. The touch sensors are distributed entirely over an effective display area of the OLED display panel, the pressure sensors are distributed near a rim of the effective display area, and the fingerprint recognition sensors are distributed at a lower portion of the effective display area. An operating method of the OLED display panel is also provided. The OLED display panel and the operating method thereof provide a product integrating three technologies, namely, touch, pressure sensing, and fingerprint recognition, in one piece.

### FIELD OF INVENTION

The present invention generally relates to the display technology and, more particularly, to an organic light-emitting diode (OLED) display panel and an operating method thereof.

### BACKGROUND OF INVENTION

With the increasing demand for full-screen mobile phones, touch, pressure sensing, and fingerprint recognition technologies are becoming more and more widely used. Mobile phones, tablets, televisions and even industrial control panels are increasingly adopting these technologies.

Almost all smart phones provide touch capabilities, while higher-end smart phones provide pressure sensing and even fingerprint recognition. There are also some high-end flagship smart phones that provide these three functions—touch, pressure sensing, and fingerprint recognition. However, with no exception, they all use add-on solutions. In other words, additional modules are mounted and used, which occupies the space in the mobile phones and has negative effects on the realization of thin and light smart phones. Currently, there is neither one design that integrates these three or two functions in one piece nor one that integrates all of these functions on the panel.

For example, the touch function can be realized by coating an organic film layer, which provides touch electrodes by depositing metal electrodes and wires using processes such as physical vapor deposition (PVD) and etching, and has two modes—the self-capacitance touch and the mutual-capacitance touch. More particularly, in the design and manufacture process of an organic light-emitting diode (OLED) display device, touch electrodes are directly designed on the encapsulation or manufactured inside the cover glass to realize a touch function.

Generally, conventional fingerprint recognition adopts the capacitive fingerprint recognition technology, in which a fingerprint recognition button module is disposed in the lower frame of a mobile phone. The button module has a capacitance sensing electrode array, and reacts to the unevenness of the fingerprint according to the capacitance. Fingerprint recognition is implemented by the charging and discharging of each capacitor. In recent years, the optical fingerprint recognition technology and the ultrasonic fingerprint recognition technology have become popular, enriching the fingerprint recognition solutions, but they are still implemented by add-on fingerprint recognition modules.

The mainstream of the pressure sensing technology is to attach a sensing film on the back of a display module and then connect the main board through the circuit on the sensing film to realize the pressure sensing function by the control operation of the main board. In recent years, there have also been technical development cases in which the pressure sensing function is embedded in the non-effective display area on both sides of the module, or in the effective display area.

However, the technical design that integrates three sensing technologies, touch, pressure sensing, and fingerprint recognition, is still rarely seen.

With the rise of the OLED display technology, especially the development of flexible and foldable OLED technology, various novel technology concepts for sensor products should also be developed.

### SUMMARY OF INVENTION

Therefore, one object of the present invention is to provide an organic light-emitting diode (OLED) display panel and an operating method thereof, realizing a novel OLED display panel and integrating three technical functions of touch, pressure sensing, and fingerprint recognition.

To achieve the foregoing object, the present invention provides an OLED display panel including touch sensors, pressure sensors and fingerprint recognition sensors integrated in the OLED display panel, the touch sensors being distributed entirely over an effective display area of the OLED display panel, the pressure sensors being distributed near a rim of the effective display area, and the fingerprint recognition sensors being distributed at a lower portion of the effective display area.

More particularly, the touch sensors are resistive or capacitive touch sensors.

More particularly, the capacitive touch sensors are self-capacitive or mutual-capacitive touch sensors.

More particularly, the pressure sensors are resistive or capacitive pressure sensors.

More particularly, the fingerprint recognition sensors are optical, capacitive or ultrasonic fingerprint recognition sensors.

More particularly, the OLED display panel is a non-foldable display panel or a foldable display panel.

More particularly, the fingerprint recognition sensors are distributed in a fingerprint recognition area, the fingerprint recognition area being a single sensor area or comprising a plurality of separate sensor areas.

More particularly, each of the plurality of separate sensor areas has a circular shape or a polygonal shape.

More particularly, the fingerprint recognition sensors are capacitive fingerprint recognition sensors, the touch sensors are mutual-capacitive touch sensors, and the mutual-capacitive touch sensors and the capacitive fingerprint recognition sensors disposed in the fingerprint recognition area share metal sensor pads connected to first peripheral circuits controlled to switch by a first enable signal and connected to second peripheral circuits controlled to switch by a second enable signal so as to control a fingerprint recognition function and a touch function to be conducted in a time-sharing manner by the first enable signal and the second enable signal with different timings.

More particularly, the touch sensors are in-cell, on-cell or add-on touch sensors.

The present invention further provides an operating method of the foregoing OLED display panel, including:

sensing the start of use of an apparatus by a user through the pressure sensors;

displaying a fingerprint recognition area on the OLED display panel to guide the user to unlock a desktop screen through the fingerprint recognition sensors; and

starting to use a touch function through the touch sensors after unlocking the desktop screen.

In summary, the OLED display panel and the operating method thereof according to the present invention provide a product integrating three technologies, namely, touch, pressure sensing, and fingerprint recognition, in one piece. In particular, in the flexible OLED display technology, a comprehensive application is designed. The flexible OLED display panel with three technical functions that are conducted in a time-sharing manner realizes the design of a new concept OLED display panel, which provides a solution for the development of a dynamic design for the foldable display panel with ergonomics and modern aesthetics.

### DESCRIPTION OF DRAWINGS

The technical solutions and other advantageous effects of the present invention will be apparent from the following detailed description with reference to the accompanying drawings of the embodiments of the present invention. Among the drawings,

FIG. 1 is a schematic diagram showing the integrated distribution of three types of sensors in a non-foldable display panel according to a preferred embodiment of the present invention;

FIG. 2 is a schematic diagram of an operating method of a non-foldable display panel according to a preferred embodiment of the present invention;

FIG. 3 is a flowchart of an operating method of an organic light-emitting diode display panel according to the present invention;

FIG. 4 is a schematic diagram showing the integrated distribution and an operating method of three types of sensors in a foldable display panel according to another preferred embodiment of the present invention;

FIG. 5 is a schematic diagram showing the integrated distribution of capacitive fingerprint recognition sensors and mutual-capacitive touch sensors according to another preferred embodiment of the present invention; and

FIG. 6 is a schematic diagram showing the integrated distribution of pressure sensors according to another preferred embodiment of the present invention.

### DETAILED DESCRIPTION OF PREFERRED EMBODIMENTS

The invention provides an organic light-emitting diode (OLED) display panel integrating three technologies, namely, touch, pressure sensing, and fingerprint recognition, and mainly including touch sensors, pressure sensors and fingerprint recognition sensors integrated in the display panel. The touch sensors are distributed entirely over an effective display area of the OLED display panel, the pressure sensors are distributed near a rim of the effective display area, and the fingerprint recognition sensors are distributed at a lower portion of the effective display area.

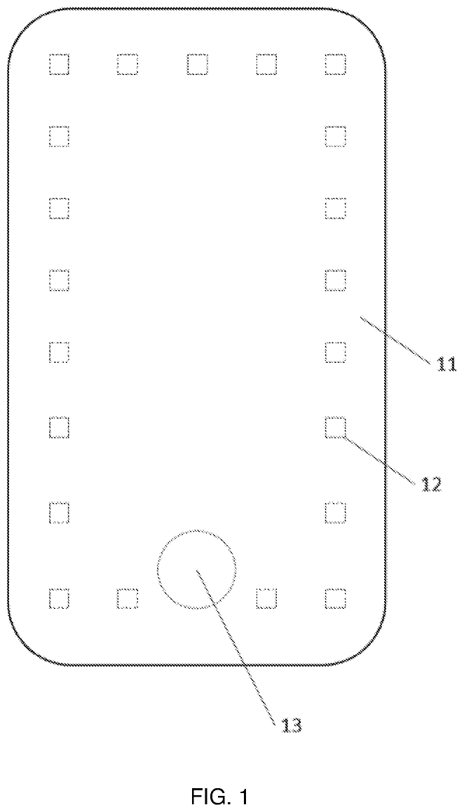

FIG. 1 is a schematic diagram showing the integrated distribution of three types of sensors in a non-foldable display panel according to a preferred embodiment of the present invention. In an effective display area (AA) 11 of the current mainstream non-foldable organic light-emitting diode display panel, touch sensors (not shown) are distributed throughout the effective display area 11, pressure sensors 12 are distributed near the rim of the effective display area 11, and fingerprint recognition sensors (not shown) is distributed in a fingerprint recognition area 13 at a lower portion of the effective display area 11. Since the display panel is a three-dimensional structure, FIG. 1 is only used to show the planar positional relationship of the three sensors in the display panel.

In other embodiments, the pressure sensors may also be distributed outside the effective display area, i.e., the areas of the upper, the lower, the left and the right borders of the display panel, and the fingerprint recognition area may also be distributed anywhere along the rim of the effective display area, especially along the lower portion of the rim because the fingerprint recognition area is closer to the driver chip, which is beneficial to the wire routing process, and the deposited etching wire is short, which makes the process easy to implement.

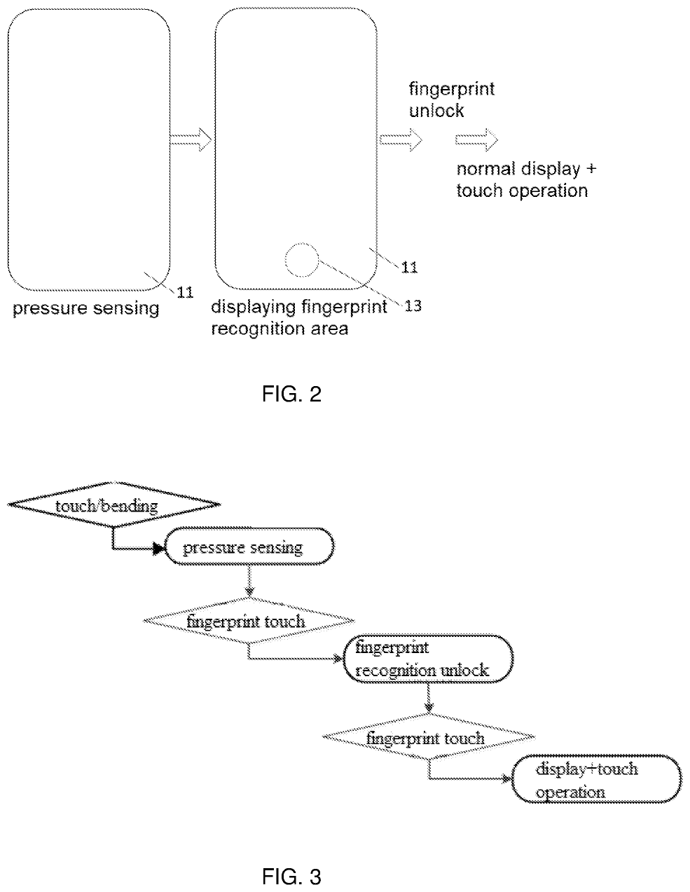

Referring to FIG. 2, FIG. 2 is a schematic diagram of an operating method of a non-foldable display panel according to a preferred embodiment of the present invention. The function of the non-foldable display panel of the preferred embodiment is implemented in a time-sharing manner. First, a smart device, such as a smart phone or a tablet computer, senses the start of use of the apparatus by a user through the pressure sensors, and the hand presses the surface of the display panel to generate a start signal to turn on the screen power, so that the fingerprint recognition area 13 in the effective display area 11 of the display panel emits light to display the position of the fingerprint recognition area 13 and guide the user to touch the fingerprint recognition area 13 with a finger to unlock the desktop screen. After unlocking the desktop screen, the effective display area 11 of the display panel can start normal display and the user can use the touch function to operate various applications (APPs) on the smart device in the apparatus. Thereafter, the pressure sensing function of the apparatus can also be used to implement the sensing of different pressure levels according to regular practices.

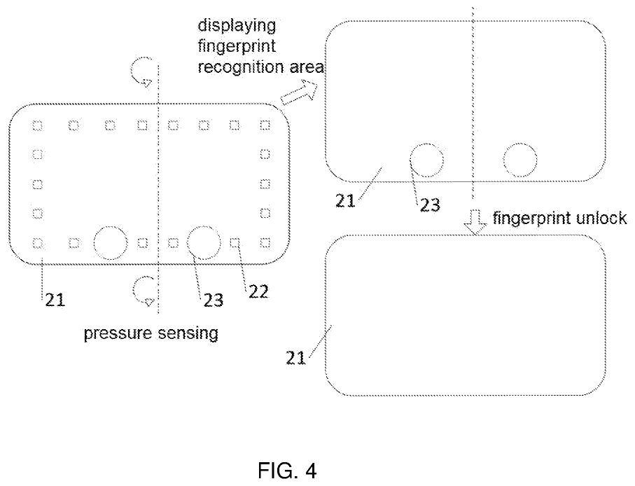

Referring to FIG. 4, FIG. 4 is a schematic diagram showing the integrated distribution and an operating method of three types of sensors in a foldable display panel according to another preferred embodiment of the present invention. In an effective display area 21 of a foldable organic light-emitting diode display panel, the distribution positions of various types of sensors are similar to those of the non-foldable display panel. Touch sensors (not shown) are distributed throughout the effective display area 21, pressure sensors 22 are distributed near the rim of the effective display area 21, and fingerprint recognition sensors (not shown) is distributed in a fingerprint recognition area 23 at a lower portion of the effective display area 21.

As shown in FIG. 4, the pressure sensors 22 are distributed inside and near the rim of the effective display area 21. In other embodiments, the pressure sensors 22 may be distributed outside the rim. The fingerprint recognition sensors are disposed in the fingerprint recognition area 23 at a lower portion of the effective display area 21. The fingerprint recognition area 23 can be disposed at any position along the rim of the effective display area 21. As shown in FIG. 4, the fingerprint recognition area 23 is a circular area. In other embodiments, the fingerprint recognition area 23 may also be a polygonal area such as a rectangle, a triangle or a diamond. As shown in FIG. 4, the fingerprint recognition area 23 may include a plurality of separate sensor areas. Each of the plurality of separate sensor areas has a circular shape or a polygonal shape. In other embodiments, the fingerprint recognition area 23 may be a single sensor area. When a design with multiple sensor areas is employed, it may be required that multiple fingers are simultaneously recognized by the fingerprint recognition sensors to unlock the desktop screen.

The use of the functions of the foldable display panel is the same as that of the functions of the non-foldable display panel. When in use, the smart device first senses that a user turns on the foldable display panel, i.e., the start of use of the apparatus by the user, through the pressure sensors to generate a start signal to turn on the screen power, so that the fingerprint recognition area 23 in the effective display area 21 of the display panel emits light to display the position of the fingerprint recognition area 23 and guide the user to touch the fingerprint recognition area 23 with a finger to unlock the desktop screen. After unlocking the desktop screen, the effective display area 21 of the display panel can start normal display and the user can use the touch function to operate various applications (APPs) on the smart device in the apparatus. Thereafter, the pressure sensing function of the apparatus can also be used to implement the sensing of different pressure levels according to regular practices.

FIG. 3 is a flowchart of an operating method of an organic light-emitting diode display panel according to the present invention. Based on the organic light-emitting diode display panel of the present invention, the present invention further provides a corresponding operating method for conducting, in a time-sharing manner, these three technical functions, namely, touch, pressure sensing, and fingerprint recognition. The operating method mainly includes: sensing the start of use of an apparatus by a user through the pressure sensors; displaying a fingerprint recognition area on the OLED display panel to guide the user to unlock a desktop screen through the fingerprint recognition sensors; and starting to use a touch function through the touch sensors after unlocking the desktop screen. The specific operating method can be understood in conjunction with FIG. 2 and FIG. 4. First, when the user has not started using the smart device, for example, the smart device is in an always-on state and needs to sense the start of use of the apparatus by the user, the pressure sensors integrated on the display panel can sense whether the user has touched or bent the display panel. If the pressure sensors sense the corresponding operation, the apparatus determines that the user has started to use the apparatus. Next, according to a preset program in the apparatus, the fingerprint recognition area on the display panel can emit light or prompt in a similar manner to guide the user to touch with a finger the fingerprint recognition sensors in the fingerprint recognition area to conduct fingerprint recognition sensing to unlock the desktop screen. Then, after unlocking the desktop screen, the display panel can normally display the application of the smart device, and the user can perform touch operations on the display panel using the touch sensors.

The OLED display panel and the operating method thereof according to the present invention fully realize the integration of the three sensors for touch, pressure sensing, and fingerprint recognition. More particularly, with the development of the flexible OLED display technology, the sensor functions of the present invention are integrated into a dynamic design for the foldable display panel, which provides an ergonomic and modern aesthetic solution. In the OLED display panel and the operating method thereof according to the present invention, the OLED display panel can be a non-foldable display panel or a foldable display panel. The touch sensors can be resistive or capacitive touch sensors. The capacitive touch sensors can be self-capacitive or mutual-capacitive touch sensors. The pressure sensors can be resistive or capacitive pressure sensors. The fingerprint recognition sensors can be optical, capacitive or ultrasonic fingerprint recognition sensors. The following further describes the specific method for integrating touch, pressure sensing, and fingerprint recognition according to the present invention.

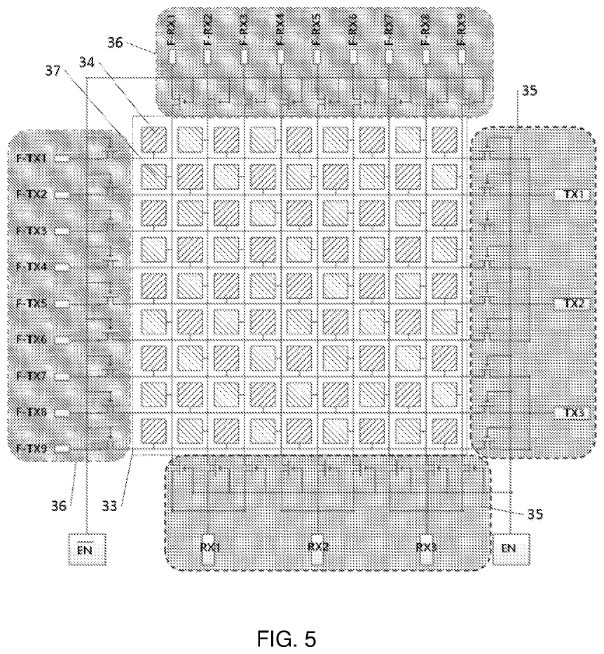

As shown in FIG. 5, FIG. 5 is a schematic diagram showing the integrated distribution of capacitive fingerprint recognition sensors and mutual-capacitive touch sensors according to another preferred embodiment of the present invention. The OLED display panel of a further preferred embodiment can be generally referred to FIG. 1 or FIG. 4. The fingerprint recognition area 33 is disposed near the rim at a lower portion of the effective display area. The touch sensors are distributed entirely over the effective display area. The preferred embodiment is specific because the touch sensors in the entire effective display area including the fingerprint recognition area 33 are designed to be mutual-capacitive touch sensors and the fingerprint recognition sensors in the fingerprint recognition area 33 are capacitive fingerprint recognition sensors. The mutual-capacitive touch sensors in the fingerprint recognition area 33 share the metal sensor pads 34, 37 with the capacitive fingerprint recognition sensors. The common metal sensor pads 34, 37 are connected to first peripheral circuits 35 controlled to switch by a first enable signal EN on the one hand, and to second peripheral circuits 36 controlled to switch by a second enable signal E̅N̅ on the other hand. The first peripheral circuits 35 are configured to connect the common metal sensor pads 34, 37 to touch transmitting signal sources and touch receiving signal sources, and the second peripheral circuits 36 are configured to connect the common metal sensor pads 34, 37 to fingerprint recognition transmitting signal sources and fingerprint recognition receiving signal sources, so as to control the fingerprint recognition function and the touch function to be conducted in a time-sharing manner by the first enable signal EN and the second enable signal E̅N̅ with different timings. On one hand, the metal sensor pads 34 and the metal sensor pads 37 are respectively used as different electrodes of the mutual-capacitive touch sensors. On the other hand, the metal sensor pads 34 and the metal sensor pads 37 are also used as different electrodes of the capacitive fingerprint recognition sensors, respectively. The metal sensor pads 34 and the metal sensor pads 37 may be alternately arranged in an array. The metal sensor pads 34 may be arranged in a lateral direction, and the metal sensor pads 37 may be arranged in a longitudinal direction.

As is known to those skilled in the art, the touch sensors are required to have a lower density and the fingerprint recognition sensors are required to have a higher density. Therefore, the density of the fingerprint recognition sensors in the fingerprint recognition area 33 may be N times the density of the corresponding touch sensors, where N may be a natural number, and N may be a multiple of 3 or of other numbers. Here, N=3 is taken as an example for description. In other words, the number of fingerprint recognition sensors in the fingerprint recognition area 33 is three times the number of touch sensors. As shown in FIG. 5, in the periphery of the effective display area, the switches of the first peripheral circuits 35 and the second peripheral circuits 36 can be controlled by the first enable signal EN and the second enable signal E̅N̅ with different timings to conduct the fingerprint recognition function and the touch function in a time-sharing manner.

1. During the operation period of a touch function, thin-film transistor switches (i.e., the touch function switches) in the first peripheral circuits 35 are turned on, and thin-film transistor switches (i.e., the fingerprint recognition function switches) in the second peripheral circuits 36 are turned off. Meanwhile, every 3 (horizontal direction)×3 (vertical direction) metal sensor pads 34, 37 are connected to the same pair of touch transmitting signal sources (TX1-3) and touch receiving signal sources (RX1-3) to implement the touch function.

2. During the operation period of a fingerprint recognition function, thin-film transistor switches (i.e., the touch function switches) in the first peripheral circuits 35 are turned off, and thin-film transistor switches (i.e., the fingerprint recognition function switches) in the second peripheral circuits 36 are turned on. Each of the metal sensor pads 34, 37 is respectively connected to different fingerprint recognition transmitting signal sources (F-TX1-9) and fingerprint recognition receiving signal sources (F-RX1-9) so that the fingerprints can be individually sensed.

In still another preferred embodiment, referring to FIG. 1 and FIG. 4, the pressure sensors can be disposed in near the rim of the effective display area on the display panel. When a hand opens a folded display panel or picks up a smart device such as a smart phone and a finger presses the rim of the effective display area, which is sensed by the pressure sensors, a signal is sent to a driver chip and then the driver chip communicates with a motherboard chip or sends a signal to the motherboard chip to inform the user that the smart phone is about to be used. The motherboard turns on the smart phone so that the display panel displays patterns of different colors in the fingerprint recognition area and guides the user to perform fingerprint unlock, thereby performing subsequent operations.

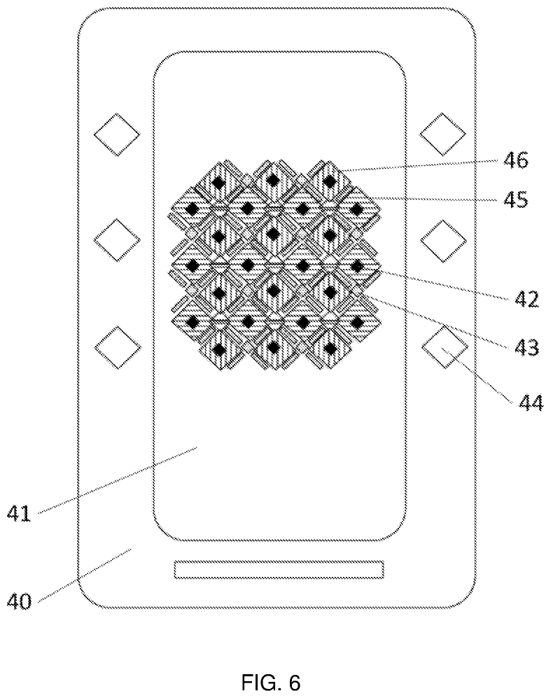

The integration of pressure sensors in the OLED display panel according to the present invention can be implemented in a variety of ways. For example, the touch sensors in the OLED display panel according to the present invention may be in-cell, on-cell or add-on, and the corresponding specific pressure sensors may be resistive or capacitive. As shown in FIG. 6, FIG. 6 is a schematic diagram showing the integrated distribution of pressure sensors according to another preferred embodiment of the present invention.

1. The pressure sensors can be integrated in the effective display area 41 of the OLED display panel.

\textcircled{1}When an on-cell touch design is used in the effective display area 41, either a resistive pressure sensor 42 is placed at the center of each touch metal sensor pad 45 or 46, or a resistive pressure sensor 43 is placed between four touch metal sensor pads 45 or 46. The leads of the pressure sensors 42 and/or 43 are preferably disposed in a first metal layer (M1) of the touch panel, and the pressure sensors 42 and/or 43 are disposed on the first metal layer (M1) or a second metal layer (M2).

\textcircled{2}When an add-on touch design is used in the effective display area 41, the pressure sensors can be directly deposited on the touch/fingerprint recognition sensors. Both resistive and capacitive pressure sensors can be used.

2. The pressure sensors 44 can be integrated in the rim 40 of the OLED display panel.

\textcircled{1} An in-cell design can be used for the pressure sensors 44.

The resistive pressure sensors 44 can be fabricated in a polysilicon layer, a first gate layer (GE1), a second gate layer (GE2), a source/drain layer (SD) or an anode layer.

\textcircled{2} An on-cell design can be used for the pressure sensors 44. The resistive/capacitive pressure sensors 44 can be fabricated on a thin-film encapsulation (TFE).

\textcircled{3} An add-on design can be used for the pressure sensors 44. In a touch panel, the resistive/capacitive pressure sensors 44 can be deposited directly on the touch sensors/fingerprint recognition sensors.

In summary, the OLED display panel and the operating method thereof according to the present invention provide a product integrating three technologies, namely, touch, pressure sensing, and fingerprint recognition, in one piece. In particular, in the flexible OLED display technology, a comprehensive application is designed. The flexible OLED display panel with three technical functions that are conducted in a time-sharing manner realizes the design of a new concept OLED display panel, which provides a solution for the development of a dynamic design for the foldable display panel with ergonomics and modern aesthetics.

In the above, various changes and modifications can be made by those with ordinary skill in the art in accordance with the technical solutions and technical concept of the present invention, and all such changes and modifications should fall within the scope of the present invention as defined by the appended claims.

What is claimed is:

1. An organic light-emitting diode (OLED) display panel, comprising touch sensors, pressure sensors and fingerprint recognition sensors integrated in the OLED display panel, the touch sensors being distributed entirely over an effective display area of the OLED display panel, the pressure sensors being distributed near a rim of the effective display area, and the fingerprint recognition sensors being distributed at a lower portion of the effective display area.

2. The OLED display panel of claim 1, wherein the touch sensors are resistive or capacitive touch sensors.

3. The OLED display panel of claim 2, wherein the capacitive touch sensors are self-capacitive or mutual-capacitive touch sensors.

4. The OLED display panel of claim 1, wherein the pressure sensors are resistive or capacitive pressure sensors.

5. The OLED display panel of claim 1, wherein the fingerprint recognition sensors are optical, capacitive or ultrasonic fingerprint recognition sensors.

6. The OLED display panel of claim 1, wherein the OLED display panel is a non-foldable display panel or a foldable display panel.

7. The OLED display panel of claim 1, wherein the fingerprint recognition sensors are distributed in a fingerprint recognition area, the fingerprint recognition area being a single sensor area or comprising a plurality of separate sensor areas.

8. The OLED display panel of claim 7, wherein each of the plurality of separate sensor areas has a circular shape or a polygonal shape.

9. The OLED display panel of claim 7, wherein the fingerprint recognition sensors are capacitive fingerprint recognition sensors, the touch sensors are mutual-capacitive touch sensors, and the mutual-capacitive touch sensors and the capacitive fingerprint recognition sensors disposed in the fingerprint recognition area share metal sensor pads connected to first peripheral circuits controlled to switch by a first enable signal and connected to second peripheral circuits controlled to switch by a second enable signal so as to control a fingerprint recognition function and a touch function to be conducted in a time-sharing manner by the first enable signal and the second enable signal with different timings.

10. The OLED display panel of claim 1, wherein the touch sensors are in-cell, on-cell or add-on touch sensors.

11. An operating method of an OLED display panel of claim 1, comprising:
sensing the start of use of an apparatus by a user through the pressure sensors;
displaying a fingerprint recognition area on the OLED display panel to guide the user to unlock a desktop screen through the fingerprint recognition sensors; and
starting to use a touch function through the touch sensors after unlocking the desktop screen.
